(19) United States
(12) Patent Application Publication
(10) Pub. No.: US 2005/0010423 A1
(43) Pub. Date: Jan. 13, 2005

(54) Real estate related and ancilliary services provided through a single point of sale

(76) Inventors: Dan Bagbey, St. Cloud, FL (US); John Bagbey, St. Cloud, FL (US)

Correspondence Address: Terry M. Sanks, Esquire;Beusse, Brownlee, Bowdoin & Wolter, P.A., Suite 2500, 390 North Orange Avenue, Orlando, FL, 32801, US

(21) Appl. No.: 10/444,618

(22) Filed: May 23, 2003

Related U.S. Application Data
(60) Provisional application No. 60/383,555, filed on May 24, 2002.

(51) Int. Cl. G06F 17/60

(52) U.S. Cl. 705/1

(57) ABSTRACT

A system for providing a single point of sale for transactions involving at least one of transfer of real estate, maintenance of real estate, improvement of real estate, and selection of an ancillary service, the system comprising a user interface device to allow a user to input and retrieve information specific to at least one of the transfer of real estate, the maintenance of real estate, the improvement of real estate, and the selection of the ancillary service, a database wherein information specific to at least one of the transfer of real estate, the maintenance of real estate, the improvement of real estate, and the ancillary service resides and financial information specific to the user, and real estate data specific to real estate also resides, wherein the user can use the user interface device to at least one of sell real estate, purchase real estate, secure a line of credit, use the line of credit to maintain the real estate, use the line of credit to improve the real estate, and use the line of credit to purchase the ancillary service, and wherein a user is able to obtain information about a service provider without providing user specific information.

This application claims priority of Provisional Patent Application Ser. No. 60/383,555, filed on May 24, 2002.

### BACKGROUND OF THE INVENTION

This invention relates to providing a plurality of services related to real estate, and more particularly, to a system and method for providing real estate related services at a single point of sale.

Typically, when a purchaser wishes to purchase real estate, all aspects of the transaction, from finding a desired property to completing the sale, are conducted through a real estate broker, or a real estate agent, who works for the real estate broker. The interaction with the real estate broker begins with the broker assisting with searching for the real estate, and cumulating when the final transaction is completed. When a potential purchaser begins the search, with the assistance of a real estate broker, the real estate broker will use such tools as a listing and/or Multiple Listing Service (“MLS”) to locate property that meets the buyer's and/or seller's specifications. Once a buyers identifies a piece of property to purchase, the potential purchaser will work through the real estate broker to present an offer to the seller.

Even though a typical prospective buyer of real property is usually guided through the process by a real estate agent, or broker, there are also buyers who prefer to make their purchase without the aid of a real estate broker or agent. Likewise, to save money from having to pay the agent/broker commission, some sellers of real property also prefer to not list their property with a real estate broker/agent or through a MLS. Business entities are currently available to assist a seller with selling real property where the real estate broker/agent commission and/or fee is reduced since the seller does not have to pay a commission to a broker/agent attempting to sell the property. However, there are no entities where the broker/agent commission is completely eliminated.

If the seller accepts the offer, the potential purchaser will then need other services, such as a surveyor, home inspector, real estate attorney, title company, insurance company and mortgage company, to assist in completing the transaction. Though the real estate broker may recommend providers of these services, the real estate broker does not provide these other services. Thus the potential purchaser must take time to select service providers needed to complete the purchase transaction.

After the purchase is complete, the purchaser may need other services to maintain and upkeep the real estate, such as, but not limited to, lawn service, termite service, insect service, repairs, remodeling, maintenance, home improvements, and supplies or products to replace or improve upon any structure or fixtures. Selecting providers of these services can be time consuming. For example if a property owner needs a tree trimming service, the owner may have to consider numerous listing in a phone book, or base a decision on notices left at the property by tree trimming services soliciting business. The property owner may then solicit several quotes to determine the best deal, not to mention verifying whether the prospective service provider is licensed and insured.

Through the increased use of the Internet, web sites are now available providing buyers the ability to search for and locate property specific to search criteria entered by the buyer. Even if a potential buyer locates property through a web site, they are usually affiliated with a real estate broker, or a plurality of real estate brokers. Thus, the potential buyer must use the real estate broker to proceed with viewing the prospective property and making an offer. These sites also usually provide links to other entities needed during the purchase phase, such as mortgage companies and insurance companies. Though some sites provide other services as well such as home improvement service providers, typically all that a user can do is enter contact information and wait for a return email or phone call from a service provider. Thus the user must provide either an email address or phone number. The potential buyer's email address may be sold to other business entities which in turn will send unsolicited spam email to the potential buyer. Likewise, if a phone number is provided, the user may begin receiving unsolicited phone calls from other service providers. Securing a service provider though such a system also does not guarantee that the service provider is qualified or reliable since all a service provider needs to do to be included as a prospective provider is to pay a fee.

### BRIEF DESCRIPTION OF THE INVENTION

Towards this end, homeowners and potential homeowners would benefit from a system and method wherein all aspects of purchasing and/or selling a home or real estate, maintaining the home, improving the home, and selecting other services can be conducted through a single point-of-sale or general supplier, wherein doing so would potentially reduce and/or eliminates outside costs, such as realtor commissions, and save time in selecting reputable services providers to where securing financial lines of credit and applying the lines of credits to services desired is also possible.

A system is disclosed that provides for a single point of sale for transactions involving transfer of real estate, maintenance of real estate, improvement of real estate, and/or selection of an ancillary service. The system has a user interface device. The user interface device is used by a user a user to input and retrieve information specific to the transfer of real estate, maintenance of real estate, improvement of real estate, and/or selection of the ancillary service. A database is also provided. Information specific to the transfer of real estate, maintenance of real estate, improvement of real estate, and/or an ancillary service resides in the database. Financial information specific to the user and real estate data specific to real estate also reside in the database. The user can use the user interface device to sell real estate, purchase real estate, secure a line of credit, use the line of credit to maintain real estate, use the line of credit to improve real estate, and use the line of credit to purchase an ancillary service. During a real estate transfer, such as a selling or buying real estate, the system can be used wherein no sales commission is one of the costs associated with the selling and/or purchase price.

In another preferred embodiment a method for providing a single point of sale for a transaction is disclosed. This single point of sale for the transaction is associated with a transfer of real estate, maintenance of real estate, improvement of real estate, and/or selection of an ancillary service. A user interface device is provided to allow a user to input and retrieve information responsive to the transfer of real estate, maintenance of real estate, improvement of real estate, and/or selection of the ancillary service. A database is also provided wherein information specific to the transfer of real estate, maintenance of real estate, improvement of real estate, and selection of the ancillary service resides in the database. Financial information specific to the user and real estate data specific to the real estate also reside in the database. The user can enter information into the database as well as retrieve information from the database immediately upon request. Thus as an example, if the user seeks a list of service providers, upon entering the request, a list of service providers, including contact information, is provided to the user.

In another preferred embodiment, another method for providing a single point of sale for a transaction for a transfer of real estate, maintenance of real estate, improvement of real estate, and/or selection of an ancillary service is provided. A user would access real estate information, maintenance service provider information, home improvement provider information, and/or ancillary service provider information from a database. A list of service providers for the transfer of real estate, maintenance of real estate, improvement of real estate, and/or selection of ancillary service will be displayed to the user. The user can enter information to establish a line of credit. The user can select the maintenance service provider information, home improvement provider information, and ancillary service provider information desired. The user can also pay for the maintenance service provider, supplies, home improvement service provider, and/or ancillary service provider with the line of credit.

### BRIEF DESCRIPTION OF THE INVENTION

The features and advantages of the present invention will become apparent from the following detailed description of the invention when read with the accompanying drawings in which:

FIG. 1 is a network overview of a system of the present invention;

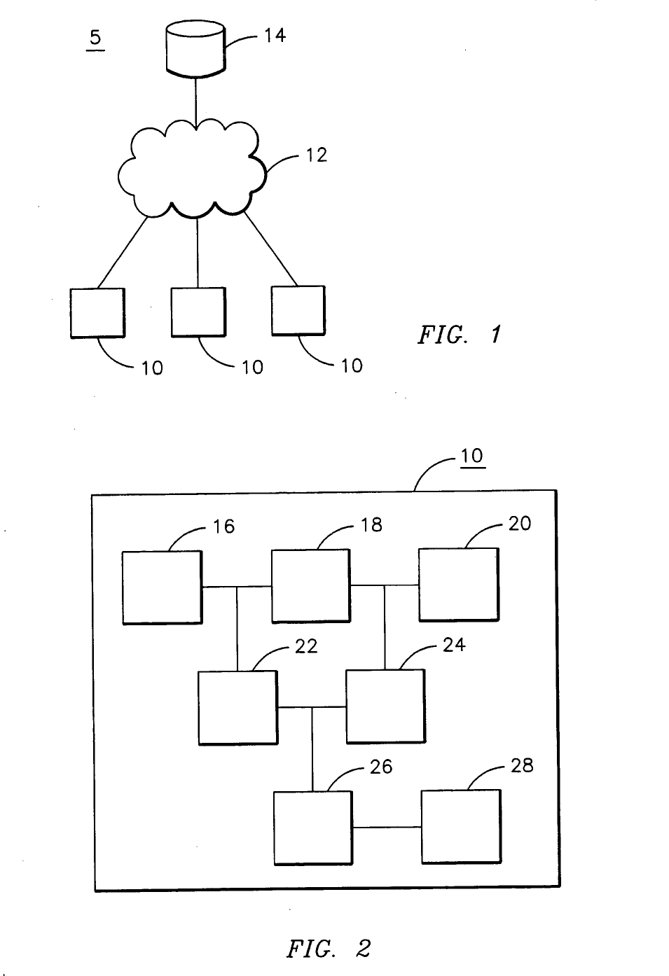

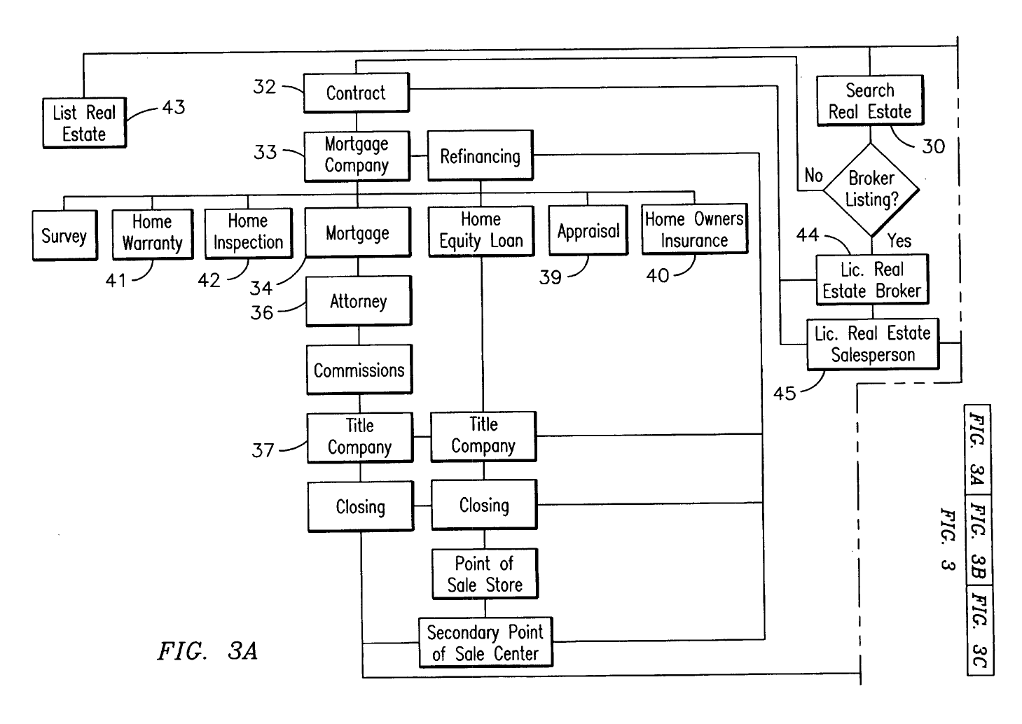

FIG. 2 is an exemplary embodiment of elements which comprise a user interface device;

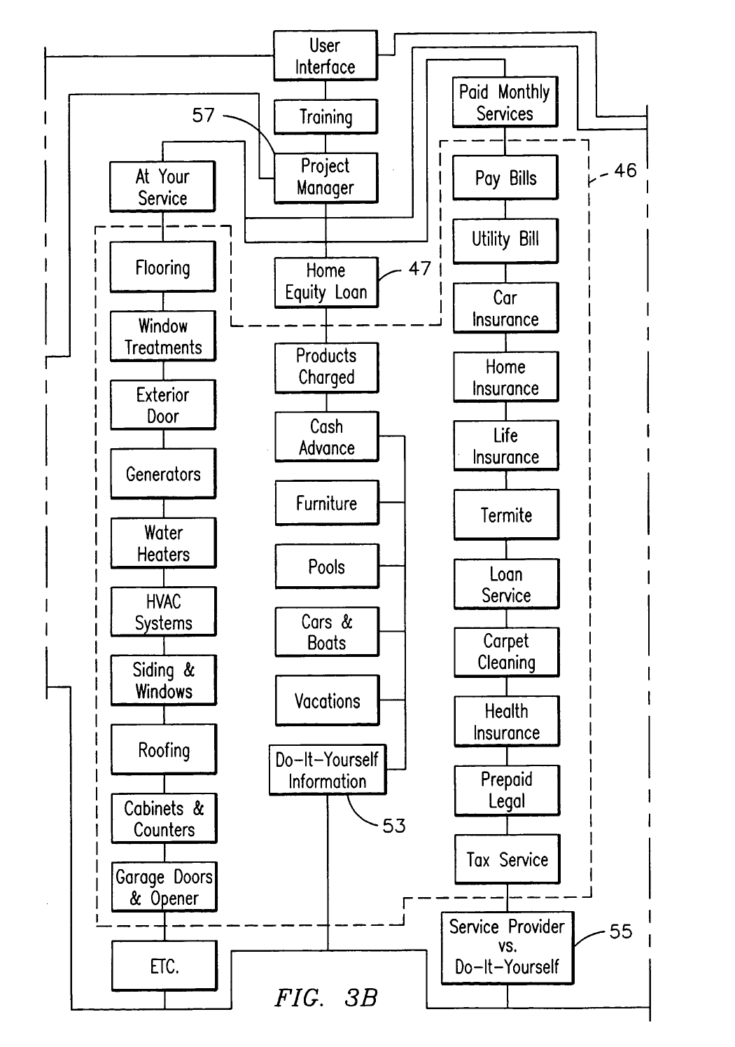

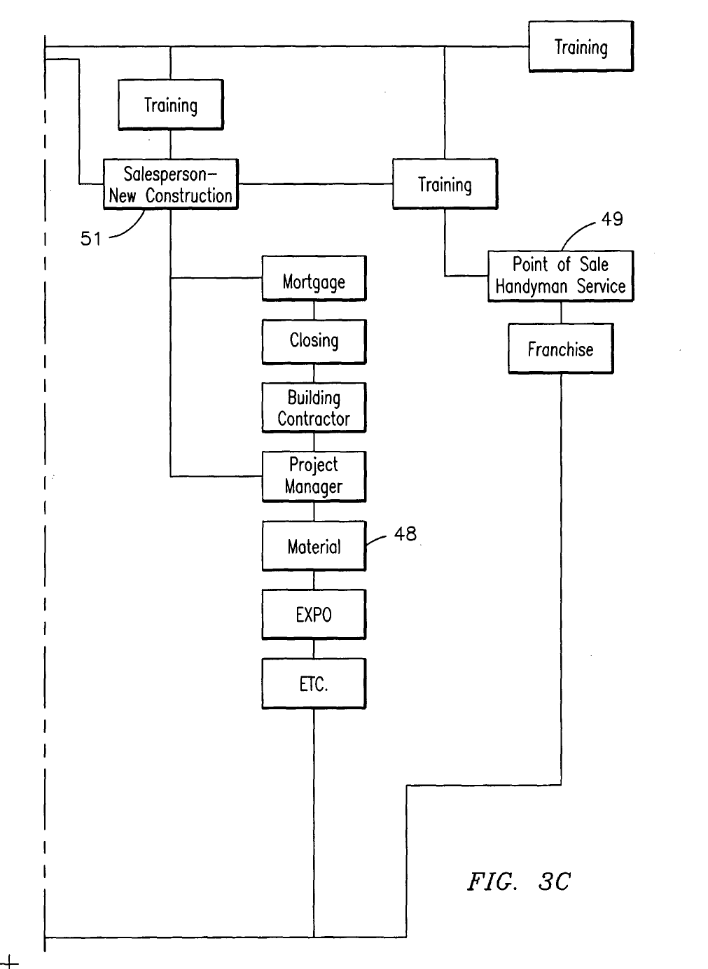

FIG. 3 is an exemplary embodiment of elements that comprise the present invention;

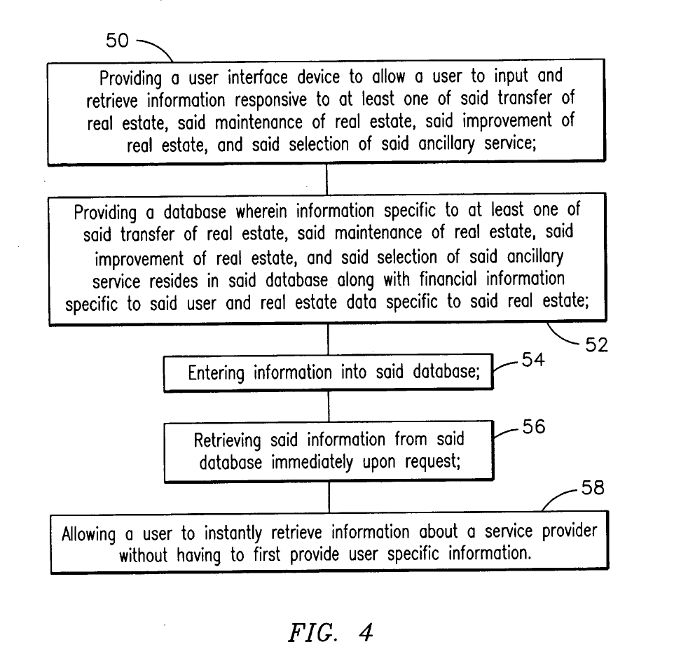

FIG. 4 is an exemplary embodiment of steps a user may follow in selecting services desired.

### DETAILED DESCRIPTION OF THE INVENTION

With reference to the figures, exemplary embodiments of the invention will now be described. The scope of the invention disclosed is applicable to a plurality of transactions involving real property. Several terms are used in describing the present invention. For example the terms real property, property, and real estate, are interchangeable with land, house, or residence, industrial property, commercial property, dwelling, residential property, etc. Similarly the transfer of real property comprises selling, buying, renting, and leasing the real property. Additionally though user and owner are used, these terms are interchangeable with seller, buyer, lessor, lessee, renter, landlord, and tenant. Terms regarding transferring the real property, such as sell, buy, lease, and rent, can also be used interchangeably. Thus, even though embodiments are described specific to selling and buying a real estate, this invention is applicable to other transfers or uses of real property or real estate, and is directed for use by the entities involved with the transfer. Likewise the list of services that a user of the present invention needs to maintain, improve, sell or buy real property is an exhaustive list. This list is also exhaustive with respect to the other services that an owner may need, such as pre-paid legal services. Thus even though several services are disclosed herein and within the figures, the present invention is not limited to just these services.

FIG. 1 is an exemplary embodiment of a network system of the present invention. As illustrated, in a preferred embodiment, the network system 5 includes remote user interface device 10, such as a computer, that is connected to a communications network 12 which connects the remote user interface device 10 to a central database 14. Though not illustrated, the user interface device 10 may be housed in a kiosk, freestanding facility, or another facility. In a preferred embodiment a plurality of remote user interface devices 10 are connected to the central database 14 through the communications network 12 where each user interface device 10 can simultaneously access the central database 14. The communications network 12 is either a closed secure network or the Internet where a secured connection is used when accessing data at the interface device 10 from the central database 14. As is discussed below, the database 14 contains a variety of different information that an owner of property, buyer of property and/or seller of property may desire. In another preferred embodiment, the remote user interface device 10 and central database 14 are a single unit where a communications network is not needed.

FIG. 2 is an exemplary embodiment of elements which comprise a user interface device. In a preferred embodiment, the user interface device comprises have a monitor 16, data entry device 18, such as a touch screen monitor, software program 20 to enable a user to utilize the functions illustrated in FIG. 3, a scanner 22, and a data-providing device 24, such as a printer. Other routines available through the user interface device 10 and are generally integrated within the software program 20 include a calendar program and a calculator program. A series of drop down screens will move the user through a series of questions. The answers will allow the user to select and complete the type of activities desired. Another part of the user interface device 10 is a processor 28 to run the software program and a storage device 26, or secondary database, to temporarily store information should the connection between the interface device 10 and database 14 is lost. In a preferred embodiment, a subset of the real estate listing for the geographic area the interface device 10 resides is maintained in the storage device 26 and is updated periodically, should the communications network become disabled.

FIG. 3 is an exemplary embodiment of services that may be available through the present invention. Through the user interface device 10, a user seeking to acquire property will be able to conduct a search for property 36 based on completing a search request. The search request criteria may include, but is not limited to, a price range, house size, location, etc. If a user identifies property that is of interest, in a preferred embodiment, the user can obtain directions to the property from either a location selected by the user or from the location of the user interface device. The user can also use the user interface device 10 to view various characteristic aspects of potential purchases, such as room dimensions, images of various rooms, house layouts and other such information including being able to take a virtual tour of the property.

If a user is ready to purchase, or acquire use of, property, the user will be able to complete all aspects of the transactions including, but not limited to, making an offer, entering into a contract 32, securing a mortgage company 33 providing a mortgage 34, having access to a real estate attorney 36, dealing and working with a title insurance company 37, securing an appraisal 39, securing homeowner's insurance 40, securing a home warranty 41, securing a home inspector to conduct an inspection 42, and/or any other services that a user may need when selling and/or purchasing, and or maintaining, the property. Likewise, a user selling property may also be able to complete all aspects of the transactions. In a preferred embodiment, using the present invention to transfer property is accomplished where a real estate sales commission is not included. Thus, the price for the property is not inflated to include the real estate commission. The commission lost by the single-point of sale operator is gained by providing other services to the user. With respect to a mortgage 42, the user has the ability to compare and contrast mortgage rates, complete an application form, design a down payment option and apply for and receive an equity secured line of credit, such as a credit card, which may be associated with the point of sale.

All necessary forms, legal requirements, loan qualification, and documentation would be formulated and viewed from the touch screen monitor 16, 18 and stored in the database 14 so that the user can save the uncompleted forms and return to the form for completion at a later time. For documents that require an actual signature, and are not acceptable with an electronic signature, the user can scan in the signed document for later retrieval by the party needing the signed document.

A user who is selling, renting or leasing property is able to list the property through the user interface device 10 and can provide contact information, such as, but not limited to, an email address and a phone number, to be notified when an offer is made on the property 43. If the user desires to post a property listing using the user interface device, the user can also scan in pictures of the property and provide dimensions of rooms, windows, doors, kitchen, bathroom facilities, etc. If a user desires to provide a virtual tour the user may also input the requisite information to provide this viewing feature of the property. In a preferred embodiment the user scans in the pictures and the present invention formats them into a virtual tour. In another preferred embodiment, a user uses another program to create the tour and then loads the tour into the present invention. The virtual tour can be stored on an electronic media storage device, such as a computer disk wherein the present invention would further include a electronic media receptacle to read extract the virtual tour from the storage device and load it into the present invention. Similarly a property owner who is undertaking improvements may also enter similar information, pictures and/or a virtual tour so that a prospective service provider or point-of-sale representative can view the area that needs improving to better assist the owner.

As previously discussed, in a preferred embodiment, a commission free listing of the property will not result in a loss of equity. Thus a buyer and/or seller will not experience an inflated cost to offset the cost of maintaining the listing. However, if property is listed where a broker/agent is representing a seller 44, 45, the user interface will also provide information, such as contact information, for the broker/agent.

A current homeowner or real property, or real estate owner can use the system to locate service providers and/or determine estimates for repair, remodel, complete maintenance and/or perform other home improvements 46, either before or after the sales purchase process where information about a service provider is readily available when accessing the system. In other words, instead of a user providing contact information and then waiting for a service provider contacting the user, the user will be able to view service providers and begin the process of hiring the service provider.

In a preferred embodiment the owner can also use the present invention to apply for a refinance package 47, including a mortgage/equity secured line of credit, such as in the form of a credit card that allows for purchase power up to the allowable credit rate in the market to buy any or all related auxiliary services or products, or consolidate and refresh credit worthiness. Financial balance information about the refinance package, or line of credit, will reside in the remote database 14. Thus whenever a user accesses the remote user device 10 to secure a service 46, the cost of the service can be deducted directly from the funds available to the user based on the refinance package 47. For example, if the user needs to purchase sod for a yard, the user can select the sod provider from the user interface device 10 and complete the financial transaction through the user interface device. The user can also use the user interface device to order other online products 48 and specify predetermined dates to allow the retail cost savings of shipping direct to the end user from the manufacturer. For recurring services, such as lawn service or pest control service, the owner can use the system to prearrange automatic, typically monthly, withdrawals from the available line of credit available. The services that a user may use the present invention to solicit and secure service providers for are not limited to services related to property. Other services, or ancillary services, such as, but not limited to, tax preparer service, health insurance, and/or pre-paid legal service. In another preferred embodiment, the present invention also has access to the user's checking account and the user can prearrange automatic withdrawals from the user's checking account to pay service providers.

Though the present invention can be located at a plurality of places, the types of transaction may be beneficial to the user if the user interface device is located at a local department store, and/or home improvement center. Towards this end, in a preferred embodiment, the present invention would be unique to a specific point-of-sale, such as a certain department store chain or a home improvement chain. In this embodiment, a user can also access services provided by the point of sale 49 and includes menu screens for a salesperson 51 to access the user's needs if the user intends to conduct a do-it-yourself project. For the user conducting a do-it-yourself project, the user interface device 10 can also provide the user with detailed how-to information for the do-it-yourself project 53. In another preferred embodiment, where a user is unsure whether to undertake a do-it-yourself project or to hire a service provider, the user interface device includes a compare and contrast feature 55 to assist the user in determining which is the most prudent approach to take considering such criteria as the user's experience, time to complete the project, and costs. If the user pursues the do-it-yourself option, the user can use the present invention to select products needed and to provide a date when the user would like the products delivered directly to the user from the manufacture, or a home improvement store. In another preferred embodiment, the present invention may be placed at a plurality of locations not associated with a single provider, such as shopping centers, malls, or facilities specific to the present invention.

The user interface device can also be used to allow contractors or subcontractors to assess the work being done on a user's property 57. Since this invention is envisioned as working from a single point-of-sale, or from a single corporate client, the contractors or subcontractors provided would be capable and well trained to complete the tasks required by the user where they would be required to meet a standard established by the single corporate client before being provided as a service provider option to the user. In any situation where a contractor, subcontractor, or sales person uses the user interface device 10, access to the property owner's financial information would not be possible. Instead of waiting for a contractor, or service provider, to contact the user, the user will be provided with information to select and contact the service provider of the user's choice.

In operation, as illustrated in FIG. 4, a user interface device is provided to allow the user to input and retrieve information, step 50. The type of information is specific to either transferring, or acquiring the use of real estate, maintaining the upkeep of the real estate, and/or improving the real estate. The database is also provided containing information specific to the acquiring, maintaining, and/or improving the real estate, step 52. The user can then either enter information specific to acquiring, maintaining, and/or improving the real estate in the database, step 54, and retrieving similar information, step 56. The user can also enter information for securing a line of credit to use for maintaining and/or improving the real estate, as well as paying for other services. The user can also select a service provider to provide said maintenance and order supplies for the improvement of the real estate wherein the user does not have to provide contact information in order to obtain contact information about the service provider, step 58. The user can also use the present invention to determine whether to select a service provider to provide a desired maintenance or whether the user should perform the maintenance.

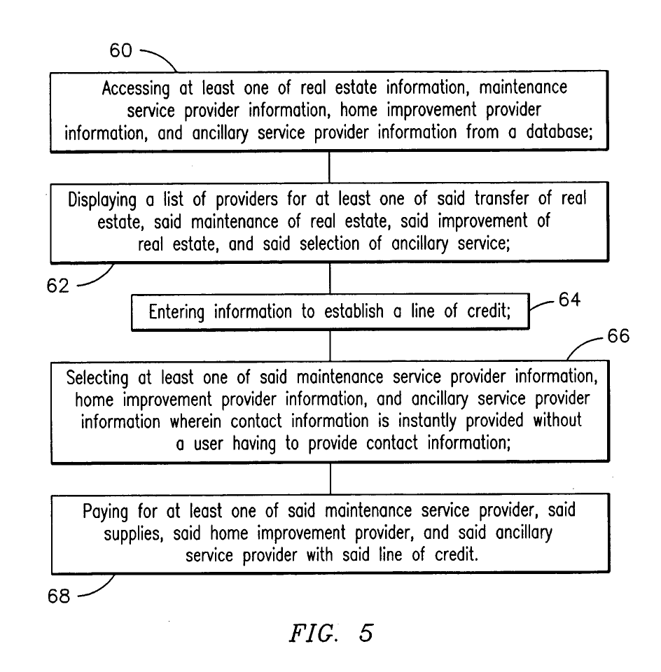

In another operational concept, as illustrated in FIG. 5, the user will access real estate information, maintenance service provider information, and/or home improvement information from a database, step 60. The user has a list of providers for either the transfer of real estate, maintenance of real estate, improvement of real estate, and selection of an ancillary service, step 62. The user can enter information to establish a line of credit, step 64. The user can select a maintenance service provider information, home improvement provider information, and/or ancillary service provider information, step 66. The user can select a service provider where contact information about the service provider is instantly provided without the user having to provide user specific contact information, step 66. The use can use the line of credit to pay for the maintenance service provider, supplies, home improvement provider, and/or ancillary service provider, step 68.

While the invention has been described in what is presently considered to be a preferred embodiment, many variations and modifications will become apparent to those skilled in the art. Accordingly, it is intended that the invention not be limited to the specific illustrative embodiment but be interpreted within the full spirit and scope of the appended claims.

1. A system for providing a single point of sale for transactions involving at least one of transfer of real estate, maintenance of real estate, improvement of real estate, and selection of an ancillary service, said system comprising:
(a) a user interface device to allow a user to input and retrieve information specific to at least one of said transfer of real estate, said maintenance of real estate, said improvement of real estate, and said selection of said ancillary service;
(b) a database wherein information specific to at least one of said transfer of real estate, said maintenance of real estate, said improvement of real estate, and said ancillary service resides and financial information specific to said user, and real estate data specific to real estate also resides;
(c) wherein said user can use said user interface device to at least one of sell real estate, purchase real estate, secure a line of credit, use said line of credit to maintain said real estate, use said line of credit to improve said real estate, and use said line of credit to purchase said ancillary service; and
(d) wherein a user is able to obtain information about a service provider without providing user specific information.

2. The system of claim 1 wherein said information about a service provider comprises information to contact said service provider.

3. The system of claim 1 further comprising a communications network that connects said user interface device to said database.

4. The system of claim 3 wherein said communications network is a secured network.

5. The system of claim 1 further comprising a plurality of user interface devices located at a plurality of locations.

6. The system of claim 1 wherein said user interface device further comprises a display device, a data entry device, and a data providing device.

7. The system of claim 6 wherein said data entry device and said display device are a touch screen monitor device.

8. The system of claim 6 wherein said data entry device is a scanner.

9. The system of claim 6 wherein said data providing device is a printer.

10. The system of claim 1 wherein said system is used to determine whether to hire a service provider to perform at least one of said maintenance of real estate and said improvement of real estate and whether to a user undertakes at least one of said maintenance of real estate and said improvement of real estate.

11. The system of claim 1 wherein said system is used to secure a line of credit using said real estate as collateral.

12. The system of claim 11 wherein said line of credit is used to fund at least one of hiring a service provider, purchasing supplies, and paying a bill.

13. The system of claim 11 wherein said line of credit is used to pay bills that recur over a predetermined time period.

14. The system of claim 1 wherein said transfer of real estate further comprises excluding a real estate sales commission from said transfer.

15. The system of claim 1 wherein a list of providers specific to said ancillary service is provided through said user interface device immediately after said list of providers is requested.

16. The system of claim 1 wherein said user interface device is used to order supplies for at least one of said maintenance of real estate, said improvement of real estate, and said ancillary service.

17. The system of claim 16 wherein said supplies purchases with a line of credit.

18. A method for providing a single point of sale for a transaction associated with at least one of a transfer of real estate, maintenance of real estate, improvement of real estate, and selection of an ancillary service, said method comprising:
(a) providing a user interface device to allow a user to input and retrieve information responsive to at least one of said transfer of real estate, said maintenance of real estate, said improvement of real estate, and said selection of said ancillary service;
(b) providing a database wherein information specific to at least one of said transfer of real estate, said maintenance of real estate, said improvement of real estate, and said selection of said ancillary service resides in said database along with financial information specific to said user and real estate data specific to said real estate;
(c) entering information into said database;
(d) retrieving said information from said database immediately upon request; and
(e) allowing a user to instantly retrieve information about a service provider without having to first provide user specific information.

19. The method of claim 18 wherein said user specific information comprises contact information.

20. The method of claim 18 further comprising providing a secure communications network connecting said user interface device with said database.

21. The method of claim 18 wherein entering said information further comprises entering information to secure a line of credit to use for at least one of said maintenance of real estate, said improvement of real estate, and said selection of said ancillary service.

22. The method of claim 18 further comprising selecting a service provider to provide at least one of said maintenance of real estate, said improvement of real estate, and said ancillary service.

23. The method of claim 22 wherein selecting a service provider further comprises displaying a list of service providers immediately after entering a request for said list of service providers.

24. The method of claim 18 further comprising ordering supplies for use with at least one of said maintenance of real estate, said improvement of real estate, and said ancillary service.

25. The method of claim 18 further comprising determining whether to select a service provider to provide at least one of said maintenance of real estate, said improvement of real estate and whether a user should perform at least one of said maintenance of real estate and said improvement of real estate.

26. The method of claim 18 further comprising transferring said real estate wherein a real estate sales commission is not included.

27. A method for providing a single point of sale for a transaction for at least one of real estate related services and ancillary services, said method comprising:
(a) accessing at least one of real estate information, maintenance service provider information, home improvement provider information, and ancillary service provider information from a database;
(b) displaying a list of providers for at least one of said transfer of real estate, said maintenance of real estate, said improvement of real estate, and said selection of ancillary service;
(c) entering information to establish a line of credit;
(d) selecting at least one of said maintenance service provider information, home improvement provider information, and ancillary service provider information wherein contact information is instantly provided without a user having to provide contact information; and
(e) paying for at least one of said maintenance service provider, said supplies, said home improvement provider, and said ancillary service provider with said line of credit.

28. The method of claim 27 further comprising incurring no real estate sales commission during said transfer of real estate.

29. The method of claim 27 further comprising entering information about said real estate.
